(19) United States
(12) Patent Application Publication
(10) Pub. No.: US 2026/0194906 A1
(43) Pub. Date: Jul. 9, 2026

(54) DYNAMIC GRID FOR OBJECT DETECTION

(71) Applicant: QUALCOMM Incorporated, San Diego, CA (US)

(72) Inventors: Thorbjoern Sven JEMANDER, Linkoping (SE); Jonas HAMMARSTROEM, Linkoping (SE); Martin OLSSON, Linkoping (SE)

(21) Appl. No.: 19/014,743

(22) Filed: Jan. 9, 2025

(51) Int. Cl. G05D 1/246; G05D 109/10; G05D 111/30; G05D 111/67; H04W 4/44

(52) U.S. Cl. CPC G05D 1/2464; H04W 4/44; G05D 2109/10; G05D 2111/32; G05D 2111/67

(57) ABSTRACT

Certain aspects of the present disclosure provide techniques for performing object detection including obtaining sensor data from one or more sensors; determining first grid parameters for a first grid based on information about a location where an object of interest is likely to be located in a scene, the first grid parameters associated with a first area of the scene including the location; generating a first scene representation of the first area based on the first grid parameters for the first grid and the sensor data; and obtaining detection information from the first scene representation.

### INTRODUCTION

### Field of the Disclosure

Aspects of the present disclosure relate to object detection.

### Description of Related Art

Sensor(s) and processing system(s), such as in autonomous or semi-autonomous vehicles, may be utilized to perceive and analyze an environment in which they operate. Some approaches may rely on processing sensor data, such as images, radar data, LiDAR point clouds, or any combination thereof, to generate a (e.g., unified) representation of the environment. A common approach involves projecting sensor data onto a bird's eye view (BEV) grid to enable object detection, tracking, motion planning, or the like. In the example of a vehicle, the BEV representation may be used for object detection around the vehicle.

Managing computational resources when attempting to detect objects over a greater detection range, such as further from a sensor, such as in a vehicle, may present a challenge when implementing a BEV-based perception system. Existing systems may utilize a single, fixed BEV grid, such as centered on an ego vehicle, for object detection. A BEV grid may refer to a structured representation of an environment that organizes sensor data into a defined spatial format, such as used for object detection. However, the computational cost of maintaining and processing such a grid grows as a desired detection range increases. In particular, when using a single, fixed BEV grid, to be able to detect objects both near and at long range, the size, resolution, or the like of the BEV grid may be increased significantly, thereby increasing computational cost to process the BEV grid. The scaling of such computational cost may make it impractical to expand the size of a single grid to achieve greater detection ranges. For example, doubling the detection range can increase computational costs by a factor of four or more, which may exceed available computing resources in some implementations.

While some existing systems may attempt to address this challenge by implementing separate detection stacks for each of short-range and long-range sensing, such approaches may not be able to provide dynamic detection ranges. Further, such approaches may not be suitable for use with sensor fusion techniques, which may provide improved object detection accuracy. For instance, some existing systems may use dedicated long-range cameras and dedicated short-range cameras with separate processing pipelines; however, utilizing such an approach may not take advantage of complementary sensor data (e.g., camera, radar, and LiDAR) at longer ranges. Other systems may reduce grid resolution at greater distances, potentially compromising detection accuracy where precise object tracking may still be needed. Additionally, conventional fixed-grid approaches may struggle to efficiently allocate computational resources, wasting processing power on regions of limited interest while lacking sufficient resolution in critical areas like intersections or merging zones.

### SUMMARY

One aspect provides a method for performing object detection. The method includes obtaining sensor data from one or more sensors; determining first grid parameters for a first grid based on information about a location where an object of interest is likely to be located in a scene, the first grid parameters associated with a first area of the scene including the location; generating a first scene representation of the first area based on the first grid parameters for the first grid and the sensor data; and obtaining detection information from the first scene representation.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example system for generating a grid in accordance with aspects of the present disclosure.

FIG. 2 depicts an example system for performing object detection in accordance with aspects of the present disclosure.

FIG. 3 depicts an exemplary system for performing multi-sensor fusion using a grid-based approach.

FIG. 4 depicts a system that implements object-level fusion for sensor data processing and object tracking in accordance with aspects of the present disclosure.

FIG. 5 depicts an exemplary system for performing feature-level extraction for object detection in accordance with examples of the present disclosure.

FIG. 6 depicts additional details directed to performing low-level feature fusion in accordance with aspects of the present disclosure.

FIG. 7 depicts a system for placing one or more grids on an extrapolated model of a road in accordance with aspects of the present disclosure.

FIG. 8 illustrates an example artificial intelligence (AI) architecture in accordance with aspects of the present disclosure.

FIG. 9 illustrates an example AI architecture of a first device that is in communication with a second device in accordance with aspects of the present disclosure.

FIG. 10 illustrates an example artificial neural network in accordance with aspects of the present disclosure.

FIG. 11 depicts a method for performing object detection in accordance with aspects of the present disclosure.

FIG. 12 depicts aspects of an example processing system for performing object detection in accordance with aspects of the present disclosure.

### DETAILED DESCRIPTION

Aspects of the present disclosure provide apparatuses, methods, processing systems, and computer-readable mediums for performing dynamic grid object detection.

Object detection may be performed by generating and utilizing scene representations of environments. In some aspects, a scene representation may refer to a structured interpretation of sensor data that captures the physical environment, including any objects. The physical environment may be, for example, the environment surrounding a vehicle, such as an autonomous or semi-autonomous vehicle. Such vehicle may be referred to as the “ego” vehicle as the scene representation is with respect to the vehicle. The scene representation may be derived from data collected by one or more sensors, such as but not limited to, camera(s), radar device(s), light detection and ranging (LiDAR) device(s), or the like. Where there is more than one sensor, each sensor may provide data corresponding to its own view or perspective of the environment. Though certain aspects are discussed herein with respect to object detection by a vehicle, such as an autonomous or semi-autonomous vehicle, it should be noted that the object detection techniques discussed herein may be performed by any suitable processing system (including one or more memories and one or more processors), device, or the like.

In some aspects, the captured sensor data, which in some cases may represent multiple viewpoints and sensor modalities, may undergo processing to generate a scene representation, such as corresponding to an environment surrounding an ego vehicle. This processed scene representation may be provided to downstream applications for tracking objects, such as for making driving decisions, such as issuing lane-departure warnings, executing lane-assist operations, or performing autonomous driving maneuvers. An example of such a processed scene is a BEV representation. A BEV representation may refer to a scene representation that provides a top-down perspective of the environment, such as surrounding the ego vehicle. To create the BEV representation, data from the one or more sensors may be obtained and used to provide one or more views of the vehicle's surroundings, referred to as a perspective view (PV). The data from the sensor(s) may then be processed by one or more PV encoders, which may use machine learning or other processing techniques to identify features from each view and provide data representing such features in a more compact form, such as a vector or tensor representation.

In some aspects, the processed data may be transformed into the BEV representation using a view transform, which may combine the processed data from the perspective views into the combined top-down perspective. In some aspects, sensor fusion may be employed during this process to combine complementary data from multiple sensors, such as cameras, LiDAR, and radar. In some aspects, sensor fusion integrates features from different sensor modalities, such as depth, motion, and texture, into a single cohesive data structure, such as a BEV tensor. In some aspects, a BEV tensor may refer to an n-dimensional array that represents spatial features of a scene from a top-down perspective. In some aspects, a BEV tensor may organize the features of the environment into a grid, where each cell or voxel of the grid corresponds to a specific area around the vehicle and includes information derived from the sensor data, such as objects in the area, their distance, motion, and/or other attributes.

In some aspects, the BEV tensor may be processed by one or more BEV encoders and decoders to generate output tensors representing features in the environment, such as nearby vehicles, pedestrians, road features, or traffic signs. For example, an output tensor could indicate the likelihood of a pedestrian in a specific area or describe the shape of a road segment ahead. In some aspects, by incorporating fused data from multiple sensors, the output tensors can provide a more comprehensive representation of the environment and be used to more accurately identify and track objects.

As discussed, when attempting to extend detection capabilities beyond typical ranges from an ego vehicle, implementing object detection, and in some cases sensor fusion, for a single BEV grid can introduce computational challenges. As discussed, a BEV grid may refer to a structured representation of an environment that organizes sensor data into a defined spatial format, such as used for object detection. In certain aspects, a BEV grid represents the environment as a series of spatial cells or voxels, where each cell corresponds to specific areas of the environment, and contains information derived from sensor data such as object positions, distances, movement attributes, or the like. A BEV grid may be used to identify and track objects by associating detected features or motion patterns with specific regions of the grid. In some systems, which may rely on fixed or static detection grids, inaccuracies and/or increased computational overhead may be encountered when an object moves near the boundaries of a single grid. For example, the BEV grid may cover an increased distance or range from a vehicle, such as an ego vehicle. More specifically, the computational cost of maintaining a single BEV grid may increase superlinearly (more than r²) and, in some configurations, cubically (r³) when a desired detection range increases. For instance, doubling a detection range can increase computational costs by a factor of four or more. Such scaling may make it impractical to expand a grid size to achieve greater detection distances, particularly when information from distant regions is less critical for real-time driving decisions.

Further, although fusing sensor information within a single BEV grid may improve object detection capabilities by using complementary sensor data, such an approach may also suffer from scaling inefficiencies.

In some aspects, to address scaling challenges associated with a large-range BEV grid, a dynamic grid (e.g., dynamic BEV grid) that can be dynamically positioned with respect to the one or more sensors (e.g., ego vehicle) and sized based on areas in the scene may be used. In particular, instead of having to increase the size of a grid to include the entire area of the scene between the vehicle and an area of interest for object detection, a position of the grid can be moved to the area of interest, thereby limiting the size of the grid used for detection, while still being used for object detection in the area of interest. By limiting the size of the grid used for object detection, object detection may be performed in the area of interest with reduced computational resources as compared to using a large-range BEV grid of a large size.

Such a dynamic grid may be a primary grid used for detection or an auxiliary grid used for detection in addition to a primary grid. One or more grids, such as one or more such dynamic grids, may be used for object detection.

In some aspects, the dynamic grid may be generated based on grid parameters, such as grid size, resolution, and position, where the grid parameters may be based on information about a location where an object of interest is likely to be located in a scene, which is an example of an area of interest. For example, the information may be the approximate location of an actual object of interest, or a location that is likely to include an object of interest. For example, where an object of interest is a vehicle, a road or intersection may be more likely to include an object of interest than a sidewalk or field, for example. In some aspects, the information about a location where an object of interest is likely to be located in a scene may include detection information from a PV decoder and/or information provided from external sources, such as map data or vehicle to everything communications (e.g., V2X).

In some aspects, the grid parameters may adapt to the location. For example, grid parameters may change such that a dynamic grid may provide increased resolution for intersections with dense traffic or road segments. In some aspects, the dynamic grid is an auxiliary grid separate from a primary grid, where the primary grid may be a grid that at least partially surrounds a vehicle. In some aspects, the dynamic grid may move, adjusting for the changing position of the location where an object of interest is likely to be located with respect to the position of the ego vehicle. By selectively and dynamically utilizing a dynamic grid, detection ranges can be extended while avoiding the scaling costs associated with a single large BEV grid. In certain aspects, this approach improves computational efficiency while maintaining or improving detection performance, such as in an area outside of a primary vehicle (e.g., ego) grid.

Aspects of the present disclosure may further address additional technical challenges that may be encountered, including challenges in object tracking, feature tracking, overlapping grids, road feature extrapolation, or the like.

For example, in some aspects, object tracking systems may encounter challenges in maintaining tracking continuity for dynamic objects as the object transitions across grids (e.g., dynamic grids, BEV grids, etc.). To address this issue, a dynamic grid may be used for tracking one or more objects, and may be referred to as a tracking grid. In some aspects, a tracking grid may be configured to follow a position (e.g., and orientation) of an object, and adapt a size, shape, and/or movement parameters of the tracking grid as the object moves through a scene. By utilizing tracking grids, aspects described herein may mitigate the limitations of static grids when handling dynamic objects, thereby increasing the accuracy of tracking objects across grid boundaries. In some aspects, benefits of this approach may include enhanced real-time detection of moving objects and reduced computational burden compared to processing data across a larger static grid.

In some aspects, challenges may be encountered when capturing and correlating features of objects or the environment when relying on object-level data, where object-level data may refer to information about an object formed based on one or more output tensors obtained from the one or more BEV encoders and decoders. In some aspects, such features may refer to detailed attributes derived from sensor data, such as edges, textures, motion cues, or surface shapes, that provide (e.g., critical) context for scene understanding. For example, features may include the edges of a vehicle, lane markings, or the texture of a road surface, which can be associated with specific spatial regions in a detection grid. In certain aspects, rather than rely on object-level data, feature tracking based on feature-level data can be used to identify and correlate features across sensor modalities and across one or more grids to improve detection and classification accuracy.

In some aspects, overlapping grids may track specific features of an object and combine such features with corresponding features obtained from other grids before determining objects for tracking or other downstream tasks. By combining features from multiple grids, certain aspects described herein may mitigate the loss of feature granularity that may be encountered when fusing objects formed within grid-specific boundaries, thereby enabling more accurate and cohesive feature extraction in the environment. In some aspects, benefits of this approach may include enhanced detection of partially occluded objects, improved recognition of road features, more accurate scene reconstruction, or the like.

In some aspects, predicting and representing road features that extend beyond the coverage of a single primary grid may be challenging, where road features may refer to elements of the driving environment, such as lane boundaries, road edges, intersections, or curves, that provide information for navigation and path planning. For example, road geometries may be derived from sensor inputs or external map data to identify areas of interest ahead of the ego vehicle. Approaches that rely solely on a single static primary grid may fail to accurately represent road features that are occluded or extend beyond the detection range of the primary grid. To address this issue, aspects of the present disclosure provide for the dynamic generation grid(s) aligned with extrapolated road features, which may be an example of a location where an object of interest is likely to be located. In some aspects, road geometries may be predicted using models derived from perspective views or BEV views. The predicted road models may enable one or more grids to be dynamically placed in regions where road features are anticipated or other locations where an object of interest is likely to be located. By utilizing road feature extrapolation and auxiliary grid placement, aspects described herein mitigate the limitations of static primary grids in detecting extended or occluded road features, thereby enhancing situational awareness and safety. In some aspects, benefits of this approach may include improved detection of upcoming road segments, better anticipation of navigation challenges, enhanced accuracy in path planning, or the like.

### Example System for Dynamic Grid Placement

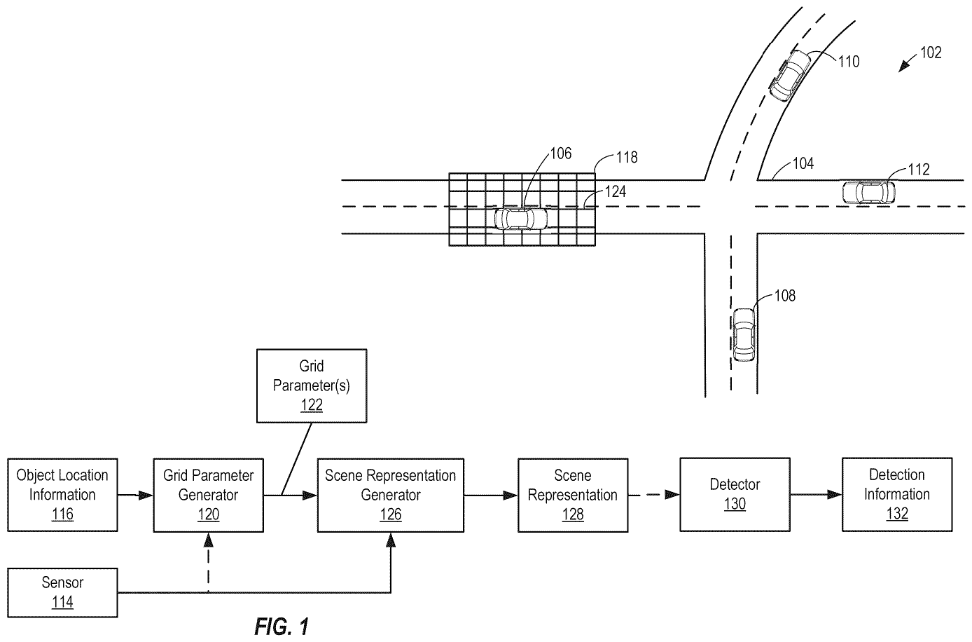

FIG. 1 depicts an example system for generating a grid in accordance with aspects of the present disclosure. In some aspects, the system may reference scene 102, which may represent an example environment in which one or more vehicles may operate. Scene 102 may include one or more objects, such as vehicle 106, vehicle 108, vehicle 110, and vehicle 112. Scene 102 may include one or more locations where an object of interest is likely to be located, such as intersection 104 and a curve on which vehicle 110 is positioned.

In some aspects, sensor 114 may obtain sensor data for an area associated with a vehicle in scene 102. In certain aspects, sensor data may refer to information captured by one or more sensing devices that represent the physical characteristics of an environment. In some aspects, the sensor 114 may include one or more image sensors, radar sensors, light detection and ranging (LIDAR) sensors, and combinations thereof. In some aspects, the sensor 114 may be mounted on a vehicle. In certain aspects, the sensor 114 may provide the sensor data to a grid parameter generator 120 and a scene representation generator 126.

In some aspects, a grid parameter generator 120 may determine grid parameters 122 based on object location information 116, such as data from sensors 114. Object location information 116 may be information about one or more locations where an object of interest is likely to be located. In certain aspects, the grid parameters may refer to characteristics that define properties of a grid structure used for organizing spatial data. In some aspects, the grid parameters 122 may include the position of the grid, the size of the grid, the shape of the grid, the orientation of the grid, the resolution of the grid, or any combination thereof. In certain aspects, the grid parameter generator 120 may dynamically adjust grid parameters based on object location information 116, which may include, for example, attributes of an object, such as but not limited to object speed or position uncertainty. In some aspects, based on the grid parameters, the grid may guide the generation of a scene representation 128, such as a BEV representation of the scene 102.

In some aspects, object location information 116 may be obtained and/or determined for the scene 102. In some aspects, the object location information 116 may include at least one of position or location data of an object, orientation data of an object, map data, road models, sensor data, trajectory data of an object, speed data of an object, vehicle-to-everything (V2X) communication data, or any combination thereof. For example, map data or road models may indicate a particular location, such as road segment, intersection, curved road segment, etc., that may likely include an object of interest. As another example, information about an object (e.g., location, speed, trajectory, orientation, etc.) may indicate a location where the object is likely to be at a time. V2X communication data may include information about an object, map data, road models, or the like, used to determine where an object of interest is likely to be located.

In some aspects, the object location information 116 may be derived from one or more sensors 114. In some aspects, image data obtained from one or more sensors may be processed by one or more PV encoders to generate feature tensors. One or more PV decoders may decode the feature tensors to determine an object's properties, such as but not limited to, location, orientation, type, or size. Alternatively, or in addition, point cloud data from one or more LIDAR sensors may be processed to directly measure a distance to an object and determine a three-dimensional position. As another example, a radar sensor may provide range and velocity measurements that contribute to object location determination using Doppler processing. In some aspects, the object location information 116 may be determined based on processing existing grids. For example, detection information based on a primary BEV grid surrounding a vehicle may be used to provide the object's location relative to the vehicle. In some aspects, the object location information 116 may be derived from predicted object locations based on tracked object trajectories and motion models.

In some aspects, one or more external sources may provide object location information 116 and/or supplement sensor-derived object location information 116. For example, and in some aspects, map data may provide road geometries and expected object locations, such as positions of intersections, lane boundaries, or traffic signs. In certain aspects, V2X communications may provide positions of other vehicles or infrastructure elements. In some aspects, the object location information 116 from various internal and external sources may be combined to generate object location information 116. In certain aspects, using data from multiple sensors to obtain object location information 116 may be beneficial when individual sources of object location information experience degraded performance due to environmental conditions, sensor limitations, or communication interruptions.

In some aspects, when multiple areas of interest are identified in a scene 102, the grid parameter generator 120 may determine and assign priority levels to each of the identified areas. In some aspects, resources (e.g., computational resources) may be allocated based on the priority levels. For example, higher priority levels may be assigned to areas closer to the ego vehicle (e.g., distance from the ego vehicle) based on their immediate relevance to safety and navigation decisions. In some aspects, areas including certain types of objects, such as pedestrians or emergency vehicles, may be assigned an elevated priority compared to areas with stationary objects. As another example, areas with more complex road features, such as merging zones may be assigned higher priority levels. Based on the determined priority levels, the grid parameter generator 120 may allocate grids to different areas of the scene (e.g., scene 102). Areas with higher priority levels may be assigned a grid having a higher resolution (e.g., increased grid cell density) or the grid may be updated more frequently. In some aspects, a grid directed to a lower priority area may have a reduced resolution (e.g., reduced grid cell density). In some aspects, the priority levels may change as the scene 102 changes. For example, if new objects enter the scene 102 or existing objects change their trajectories (e.g., predicted trajectory or actual trajectory), the priority levels associated with areas for the objects may change.

An area of the scene 118 within the scene 102 may be based on the object location information 116 and may influence one or more grid parameters 122. In certain aspects, the area of the scene 118 may refer to a region of the scene 102 that is relevant to the ego vehicle, such as which may likely include an object of interest. In some aspects, the area of the scene 118 may be determined based on one or more detected objects, information about an object, information about the location of the area of the scene 118, or the like. For example, when the vehicle 106 approaches the intersection 104 (e.g., intersection), which may be likely to include an object of interest, an area around the vehicle 106 may be identified as an area of the scene 118.

The area of the scene 118 may adapt based on changing conditions. In some aspects, as an object moves through the environment, the area of the scene 118 may be updated to maintain coverage for the object. For example, when tracking a moving object, the area of the scene 118 may move to follow an object's trajectory. In certain aspects, multiple areas of the scene 118 may be identified, where each area of the scene may be associated with another object.

In some aspects, the object location information 116 may be derived from external sources. For example, map data may provide information for upcoming road features or infrastructure elements. In some aspects, V2X communications may provide information about locations, objects, or conditions for objects beyond the sensor range of the sensor 114. Information from various information sources may be combined to identify and prioritize areas of the scene 118.

In some aspects, the area of the scene 118 may guide grid parameter generation. In some aspects, the grid parameter generator 120 may generate grid parameters 122 to improve detection capabilities within the identified area of the scene 118. For example, the grid position, size, or resolution, may be adjusted to improve detection capabilities in areas of the scene 118 while efficiently managing resource utilization across the broader scene 102.

In some aspects, the grid parameters 122 may be determined based on various characteristics of detected objects. In some aspects, when an object is detected moving at higher speeds, the grid parameter generator 120 may adjust one or more grid parameters 122 to increase a size of the grid in the direction of object motion. For slower-moving objects, the grid size may be reduced to conserve computational resources while maintaining object detection capabilities. In certain aspects, the grid parameter generator 120 may adjust a grid size to account for uncertainty associated with an object position. For example, if a measurement associated with an object position becomes less reliable, an uncertainty associated with the object position may increase. Accordingly, the grid parameter generator 120 may adjust parameters of the grid to account for the increased uncertainty by adjusting the grid cell density, grid cell size, or size of the area of the scene 118 covered by the grid.

In some aspects, the grid parameter generator 120 may adjust grid parameters in response to detecting degraded sensor data. In some aspects, sensor data degradation may occur due to various factors such as environmental conditions (e.g., rain, fog, glare), sensor malfunctions, sensor occlusions, or interference. When degraded sensor data is detected for a portion of a grid, the grid parameter generator 120 may compensate for the degraded sensor data by increasing the size of the grid to maintain a detection capability. For example, if rain or fog reduces the reliability of one or more sensor measurements in an area, the grid parameter generator 120 may expand grid boundaries to capture additional context from surrounding areas where non-degraded sensor data exists. The grid parameter generator 120 may also adjust other grid parameters, such as grid cell density or resolution.

In certain aspects, the shape and orientation of the grid may adapt to scene features. In some aspects, for curved road segments, the grid parameter generator 120 may define a non-rectangular grid shape aligned with the road geometry. The grid may widen as the distance from the vehicle increases to accommodate increasing uncertainty in road position. In certain aspects, for straight road segments, the grid parameter generator 120 may define rectangular grids oriented parallel to the road direction. In some aspects, the grid parameter generator 120 may specify higher cell density in regions closer to the vehicle or in areas requiring more precise detections, such as intersections. The grid cell density may decrease in more distant regions where coarser detection may be more acceptable.

In certain aspects, the grid parameter generator 120 may monitor available computational resources when determining grid parameters. For example, if computational resources are limited, the grid parameter generator 120 may reduce grid sizes, reduce grid cell densities, or limit the number of grids. In certain aspects, the grid parameter generator 120 may prioritize adjustments based on object types—maintaining high-resolution coverage for dynamic objects like vehicles, while reducing resolution for static objects.

In some aspects, a scene representation generator 126 may generate a scene representation 128 based on the grid parameters 122 and data from sensors 114. In certain aspects, a scene representation 128 may refer to a structured organization of detected features within a defined coordinate system that provides for an understanding of spatial relationships between objects and elements in an environment. For example, a scene representation 128 may describe positions and characteristics of vehicles, pedestrians, road features, and other objects detected in the environment.

In some aspects, the scene representation 128 may comprise a BEV representation, which provides a top-down perspective of the scene 102. As previously describe, a BEV representation may organize information into a grid structure where each grid cell may correspond to a physical area in a scene, such as scene 102. The scene representation generator 126 may project features from sensor data obtained from one or more sensors 114 onto corresponding locations within the BEV grid structure based on the grid parameters 122.

The scene representation generator 126 may perform feature extraction and projection operations. In some aspects, PV encoders may process raw sensor data to generate feature tensors representing detected characteristics. These feature tensors may then be transformed through a view transform operation that projects the features from their original sensor perspectives into the BEV coordinate system. In certain aspects, the projection process enables fusion of features from multiple sensors into a unified representation.

The grid cells within the scene representation 128 may include feature information for one or more objects in the scene 102. In some aspects, a grid cell may store feature vectors that encode information about objects or elements detected within that grid cell's physical area. In some aspects, thee feature vectors may include information about object presence probabilities, object classifications, geometric features, motion characteristics, or other attributes derived from the sensor data. In certain aspects, the feature vectors may enable downstream processing tasks while maintaining the spatial relationships of the grid structure.

In some aspects, a scene representation 128 may be generated for different areas within the scene 102. In some aspects, the scene representation generator 126 may generate a primary scene representation covering an area immediately surrounding a vehicle while simultaneously generating another scene representation for areas of the scene 102. These additional scene representations may use different grid parameters, such as higher resolution or different grid cell structures, to provide enhanced detection capabilities in areas of interest.

In some aspects, the detector 130 may process the scene representation 128 to generate detection information 132. In certain aspects, detection information may refer to processed data that identifies and characterizes objects or features within the scene 102. The detection information 132 may be provided as input for downstream vehicle control systems, navigation systems, or driver assistance features.

In some aspects, the detector 130 may employ various processing approaches to process the scene representation 128. In some aspects, the detector 130 may include one or more neural networks trained to process BEV feature tensors from the scene representation 128. For example, a first neural network may analyze feature vectors to detect and classify objects, while a second neural network may analyze temporal sequences of features to determine object trajectories. In certain aspects, the detector 130 may be configured to extract road features such as lane boundaries, intersections, or traffic signs from the scene representation 128.

The detection information 132 may include multiple data types. In some aspects, for each detected object, the detection information 132 may specify a classification (e.g., vehicle, pedestrian, bicycle), a position within the scene, an orientation, a confidence score for the detection, or the like. For moving objects, the detection information 132 may include velocity vectors, predicted trajectories, motion characteristics, or the like. The detection information 132 may also describe static elements such as road geometry, intersection locations, or traffic control devices. The detection information 132 may be utilized by one or more downstream applications, such as an object tracker, to track one or more objects obtained from the detection information 132. In some aspects, the detection information 132 may represent one or more detected objects, while in some aspects, the detection information 132 may represent one or more detected features.

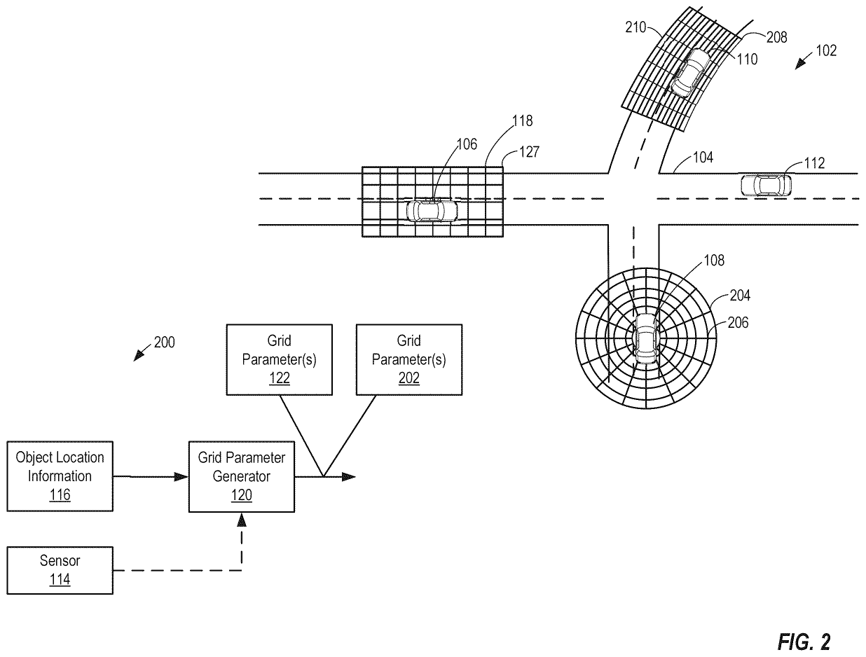

FIG. 2 depicts an example system 200 for performing multi-grid sensor fusion in accordance with aspects of the present disclosure. In some aspects, the system 200 may include the grid parameter generator 120, which may be configured to generate grid parameters for multiple grids, such as second grid parameters 202 for a main grid 206 and/or grid parameters 122 for one or more auxiliary grids 127. In certain aspects, second grid parameters 202 may be static. In certain aspects, the grid parameter generator 120 may determine grid parameters that describe characteristics of main grid 206 and/or auxiliary grid(s) 127, including, but not limited to, grid size, grid shape, grid resolution, grid position, or any combination thereof. The second grid parameters 202 and/or grid parameters 122 may be dynamically adjusted based on various factors, such as object motion, scene complexity, available computational resources, or any combination thereof.

As depicted in FIG. 2, a main grid 206 may be configured to represent an area 204 of the scene 102, and an auxiliary grid 127 may be configured to represent another area (e.g., scene 118) of the scene 102, where each area (e.g., scene 118 and/or area 204) may be part of the scene 102. As another example, an auxiliary grid 208 may be configured to represent another area (e.g., scene 210) of the scene 102, where each area (e.g., scene 210) may be part of the scene 102. The main grid 206 and/or the auxiliary grid 127 and/or auxiliary grid 208 may be dynamically positioned and sized based on the second grid parameters 202 and/or the grid parameters 122 in order to detect objects for areas in scene 102. In some aspects, the main grid 206 may be configured for tracking objects or monitoring areas proximate to the vehicle 108. An auxiliary grid, such as auxiliary grid 127, may be configured for monitoring regions beyond the immediate vicinity of the vehicle 108, such as distant roadways, intersections, or off-road areas. In some aspects, the grid parameter generator 120 may be further configured to perform at least one of determining grid parameters based on object location information, determining grid parameters based on object uncertainty, adjusting grid resolution based on distance from the ego vehicle, modifying grid shape based on road geometry, altering grid size based on object velocity; adjusting grid positioning to maintain object tracking, or the like.

In certain aspects, the system 200 depicted in FIG. 2 may be configured to integrate object detection information across multiple grids and detect and track objects across overlapping grid regions. In some aspects, such integrations may include feature-level fusion or object-level fusion, such as depending on the relative positions of the grids and characteristics of detected objects. In certain aspects, feature-level fusion may be used where grids are within a threshold distance of one another (e.g., overlap, almost overlap, etc.). In certain aspects, object-level fusion may be used where grids are not within a threshold distance of one another (e.g., do not overlap). In certain aspects, object-level fusion may involve detecting and forming objects based on individual grids before combining object detections across grids. In contrast, feature-level fusion may involve combining lower-level features extracted from the sensor data across grids prior to performing object formation. In certain aspects, system 200 is configured to transition or switch between feature-level fusion and object-level fusion based on the relative positions of grids as they grid position(s) change, such as whether grids are or are not within a threshold distance (e.g., edge of the grids are within a threshold distance).

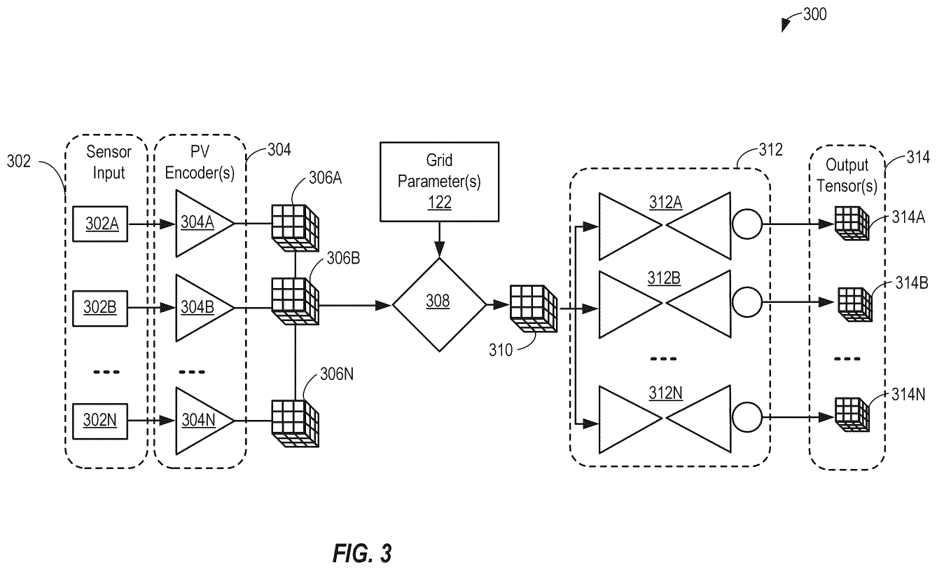

FIG. 3 depicts an exemplary system 300 for performing multi-sensor fusion using a grid-based approach. In some aspects, system 300 includes a plurality of sensors 302A-302N configured to obtain sensor data, which together form sensor input. In some aspects, a plurality of PV encoders 304A-304N may receive the sensor data from respective sensors 302A-302N. In some aspects, the PV encoders 304A-304N may generate output tensors 306A-306N. The output tensors 306A-306N may be provided to a view transformer 308.

In certain aspects, each sensor of the plurality of sensors 302A-302N may be configured to obtain sensor data of a different modality. For example, the sensor 302A may include an image sensor configured to capture image data, the sensor 302B may include a radar sensor configured to capture radar data, and the sensor 302N may include a light detection and ranging (LIDAR) sensor configured to capture LIDAR data. Each sensor 302A-302N may be positioned on a vehicle to obtain sensor data for an area surrounding the vehicle. In certain aspects, different sensors may be of the same modality.

In some aspects, each PV encoder 304A-304N may be configured to process sensor data from a corresponding sensor 302A-302N and generate a corresponding PV encoder output tensor 306A-306N. For example, the PV encoder 304A may process image data from sensor 302A to generate the PV encoder output tensor 306A representing features extracted from the image data. The PV encoders 304A-304N may include neural networks trained to extract features from their respective sensor data types.

The view transformer 308 may be configured to receive grid parameters 122 and the PV encoder output tensors 306A-306N. Based on the grid parameters 122 and the PV encoder output tensors 306A-306N, the view transformer 308 may generate a scene representation tensor 310. In some aspects, the scene representation tensor 310 may include a BEV tensor that provides a top-down representation of features detected in the area surrounding the vehicle.

In some aspects, system 300 may include a plurality of BEV encoders and decoders 312A-312N configured to process the scene representation tensor 310 and generate corresponding output tensors 314A-314N. In certain aspects, each BEV encoder and decoder 312A-312N may be configured to detect different types of objects or features. For example, the BEV encoder and decoder 312A may be configured to detect vehicles, while the BEV encoder and decoder 312B may detect pedestrians. The output tensors 314A-314N may represent detected objects and their properties, such as position, velocity, size, orientation, class, or the like.

In some implementations, the grid parameters 122 may define properties of one or more grids used by the view transformer 308 when generating the scene representation tensor 310. The grid properties may include grid position, grid size, grid shape, grid resolution, or combinations thereof. The view transformer 308 may project features from the PV encoder output tensors 306A-306N into grid cells within the grid based on the grid parameters 122. In certain aspects, the grid parameters 122 may influence how the view transformer 308 projects features from the PV encoder output tensors 306A-306N into the scene representation tensor 310. For example, when the grid parameters 122 specify multiple grids, the view transformer 308 may selectively project features into corresponding locations within each grid. The view transformer 308 may determine whether to project a given feature into a particular grid based on whether the feature's location corresponds to an area covered by that grid.

The grid parameters 122 may also influence the resolution at which features are projected by the view transformer 308. For instance, when the grid parameters 122 specify a higher grid resolution for a particular area, the view transformer 308 may project features into that grid with increased spatial precision. Conversely, when the grid parameters 122 specify a lower grid resolution, the view transformer 308 may combine or downsample features being projected into the corresponding grid cells.

In some aspects, the grid parameters 122 may specify non-uniform grid cell sizes within a grid. For example, the grid parameters 122 may define smaller grid cells in areas closer to the vehicle and progressively larger grid cells at greater distances. In some aspects, using non-uniform grid cell sizes may provide a more efficient use of computational resources while maintaining detection accuracy.

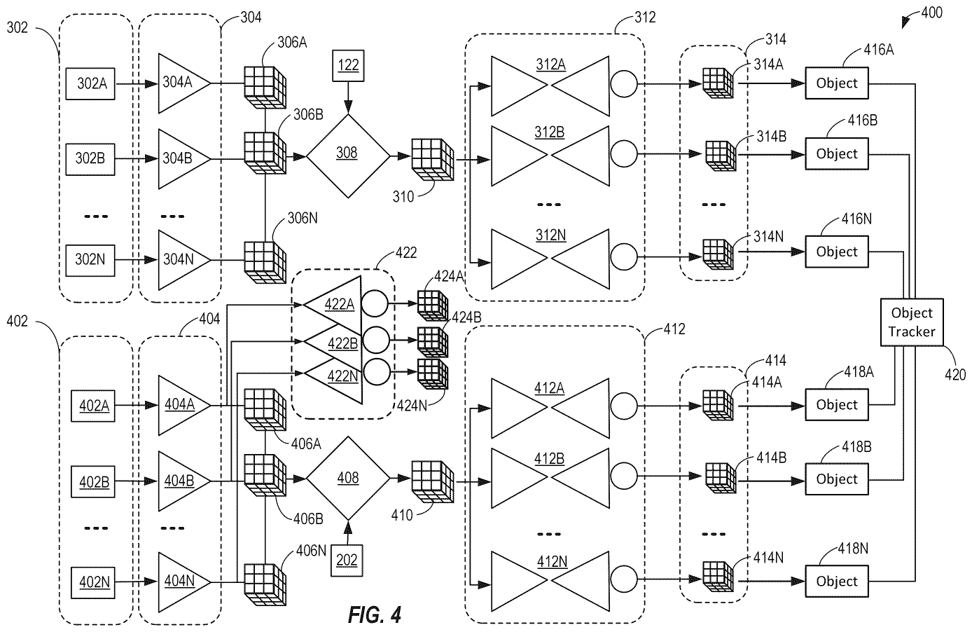

FIG. 4 depicts an exemplary system 400 that implements object-level fusion for sensor data processing and object tracking in accordance with aspects of the present disclosure. In some aspects, the system 400 may include components previously described with reference to FIG. 3, such as sensors 302A-302N, PV encoders 304A-304N, and BEV encoders and decoders 312A-312N. In some aspects, some of the sensors 302A-302N may be the same physical sensor as 402A-402N, while other sensors may be different physical sensors. For example, sensor 302A and sensor 402A may refer to the same sensor, while sensor 302B and sensor 402B may be different sensors. In some aspects, the system 400 may extend these components by incorporating an independent (e.g., parallel) processing path and object tracker 420 to enable object-level fusion across multiple grids.

In some aspects, the system 400 may include first and second independent processing paths configured to process sensor data independently before fusing detected objects at the object tracker 420. In some aspects, each processing path may be defined by a specific set of sensors, PV encoders, view transformers, and BEV encoders and decoders that may operate on different grids or different areas of the environment containing an ego vehicle. In some aspects, object-level fusion implemented by system 400 may be performed when grids from the independent paths have limited overlap, or when objects move between different grids. In such instances, like objects from each of the processing paths may be fused together and the object tracker 420 may operate on (e.g., track) the fused objects.

In some aspects, the second processing path may include sensors 402A-402N configured to obtain second sensor data, together referred to as second sensor input. PV encoders 404A-404N may receive the second sensor data from respective sensors 402A-402N and generate PV encoder output tensors 406A-406N. In some aspects, a second view transformer 408 may be configured to receive the PV encoder output tensors 406A-406N and second grid parameters 202 and generate a second scene representation tensor 410. The second BEV encoders and decoders 412A-412N may be configured to process the second scene representation tensor 410 to generate second output tensors 414A-414N and corresponding second detected objects 418A-418N.

In some aspects, the second processing path may include PV decoders 422A-422N configured to receive and process the PV encoder output tensors 406A-406N to generate PV decoder output tensors 424A-424N. In some aspects, the PV decoder output tensors 424A-424N may provide perspective-specific feature information that may be used by the BEV encoders and decoders 412A-412N and/or the grid parameter generator 120 to generate second grid parameters 202.

In certain aspects, each BEV encoder and decoder 312A-312N and 412A-412N may be configured to detect objects or features, with different encoders and decoders detecting different types of objects. For example, some encoders and decoders may be configured to detect vehicles, while others may be configured to detect pedestrians, bicycles, or static road features. In some aspects, the first detected objects 416A-416N may be formed based on the output tensors 314A-314N generated by the first BEV encoders and decoders 312A-312N. In some aspects, to form an object (e.g., object 416A-416N), the formation process may involve converting tensor representations into structured object data, including properties and attributes describing physical objects detected in the environment.

For example, the output tensor 314A may include encoded information about object presence probabilities, dimensional parameters, positional coordinates, and motion characteristics for a scene representation tensor 310. In some aspects, the system 400 may process this encoded information to form object 416A by extracting and organizing the parameters into a data structure representing a physical object. The formed object 416A may include attributes such as an object type classification, a three-dimensional bounding box defining the object's spatial extent, a position vector indicating the object's location, a velocity vector indicating the object's motion, associated confidence scores for the extracted parameters, or the like.

Similarly, the second detected object(s), 418A-418N, may be formed based on the output tensors 414A-414N generated by the second BEV encoders and decoders 412A-412N. In certain implementations, the formation of objects 418A-418N may additionally utilize information from the PV decoder output tensors 424A-424N to refine or validate object properties based on perspective-specific features. Formation of an object, may refer to formation of a detection of an object, and not physical formation of the object itself.

In some aspects, the system 400 further includes an object tracker 420 configured to receive and fuse the first detected objects 416A-416N and second detected objects 418A-418N. In some aspects, the object tracker 420 may associate objects across multiple frames to maintain temporal consistency in object tracking. For example, the object tracker 420 may use object attributes such as position, velocity, trajectory, or the like to associate objects over time and maintain object identities as objects move between different detection grids or through the environment.

In certain aspects, the object tracker 420 may receive the formed objects 416A-416N and 418A-418N and perform object-level fusion. In some aspects, when performing object-level fusion, the object tracker 420 may identify objects detected in the independent processing paths based on spatial proximity, motion similarity, or appearance similarity. In some aspects, the object tracker 420 may combine or average object properties for corresponding objects while accounting for detection confidence scores from each processing path.

In certain aspects, the object tracker 420 may maintain object identities as objects move between grids associated with different processing paths. For example, when an object moves from an area covered by the first processing path to an area covered by the second processing path, the object tracker 420 may use predicted object trajectories and appearance characteristics to maintain consistent object identification despite the transition between processing paths.

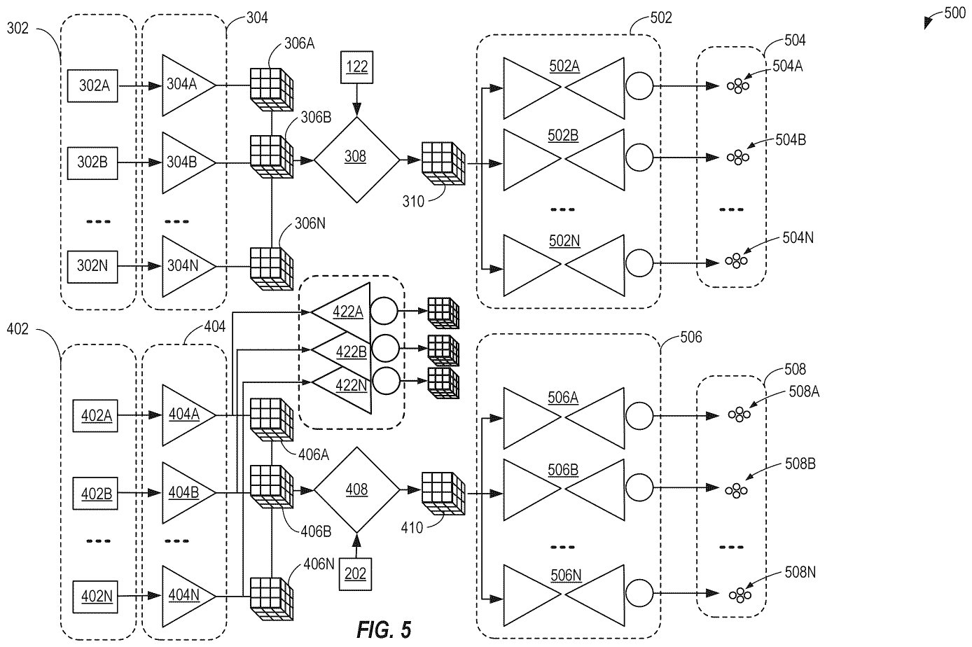

FIG. 5 depicts an exemplary system 500 for performing feature-level extraction for object detection in accordance with examples of the present disclosure. In some aspects, the system 500 may include first and second independent feature extraction pipelines configured to process scene representation tensors to generate object type-specific features.

In some aspects, the first feature extraction pipeline may include sensors 302A-302N, PV encoders 304A-304N, and view transformer 308. In some aspects the scene representation tensor 310 may be provided to feature extractors 502A-502N. In some aspects, the feature extractors 502A-502N may generate object type-specific features 504A-504N. That is, in some aspects, each feature extractor 502A-502N may be configured to extract features corresponding to a specific object type. For example, feature extractor 502A may be configured to extract features associated with vehicles, while feature extractor 502B may extract features associated with pedestrians.

In some aspects, the second feature extraction pipeline may include sensors 402A-402N (which may overlap with sensors 302A-302N from the first pipeline), PV encoders 404A-404N, and second view transformer 408. In some aspects, some of the sensors 402A-402N may be the same physical sensor as 302A-302N, while other sensors may be different physical sensors. For example, sensor 302A and sensor 402A may refer to the same sensor, while sensor 302B and sensor 402B may be different sensors. In some aspects, the second feature extraction pipeline may use the same sensors 302A-302N or a subset of sensor information from the first feature extraction pipeline. In some aspects, the second scene representation tensor 410 may be provided to feature extractors 506A-506N. In some aspects, the feature extractors 506A-506N may generate object type-specific features 508A-508N. Similar to the first pipeline, each feature extractor 506A-506N may be configured to extract features for specific object types.

In some aspects, the object type-specific features 504A-504N and 508A-508N, generated by the feature extractors 502A-502N and 506A-506N, may include data about objects of particular types. For example, features associated with vehicles may include vehicle dimensions, orientation angles, and velocity vectors. Features associated with pedestrians may include pedestrian height, walking direction, and movement patterns. These features may be provided to downstream processing components such as for object detection, tracking, or classification tasks.

In certain aspects, the feature extractors 502A-502N and 506A-506N may utilize predefined or learned characteristics associated with their target object types. For example, a vehicle feature extractor may utilize expected vehicle shapes and motion patterns, while a pedestrian feature extractor may utilize expected pedestrian sizes and walking behaviors.

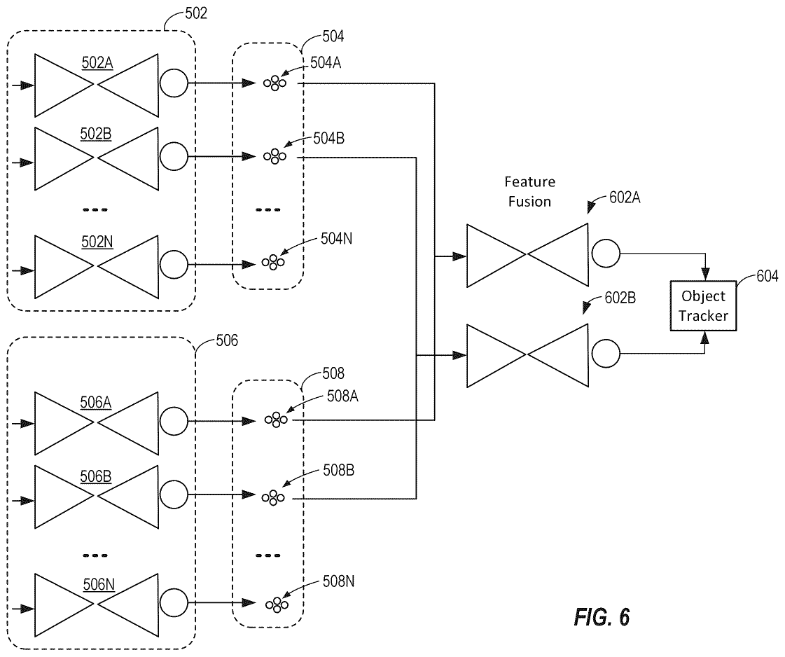

FIG. 6 depicts additional details directed to performing low-level feature fusion in accordance with aspects of the present disclosure. In some aspects, the object type-specific features 504A-504N and 508A-508N, generated by the feature extractors 502A-502N and 506A-506N may be provided as inputs to one or more feature fusion models, 602A and 602B. In some aspects, the feature fusion models 602A and 602B may be configured to align and combine object type-specific features from the first and second feature extraction pipelines to generate fused representations of detected objects. In some aspects, an object tracker 604 may be configured to receive the fused object representations from the feature fusion models 602A and 602B. In some aspects, the object tracker 604 may associate the fused object representations across multiple time steps or frames to determine object trajectories and maintain object identities over time.

In certain aspects, the object tracker 604 may employ one or more tracking algorithms such as Kalman filters, optical flow, or deep learning-based approaches to predict object motion and update object states based on the fused object representations from the feature fusion models 602A-602B.

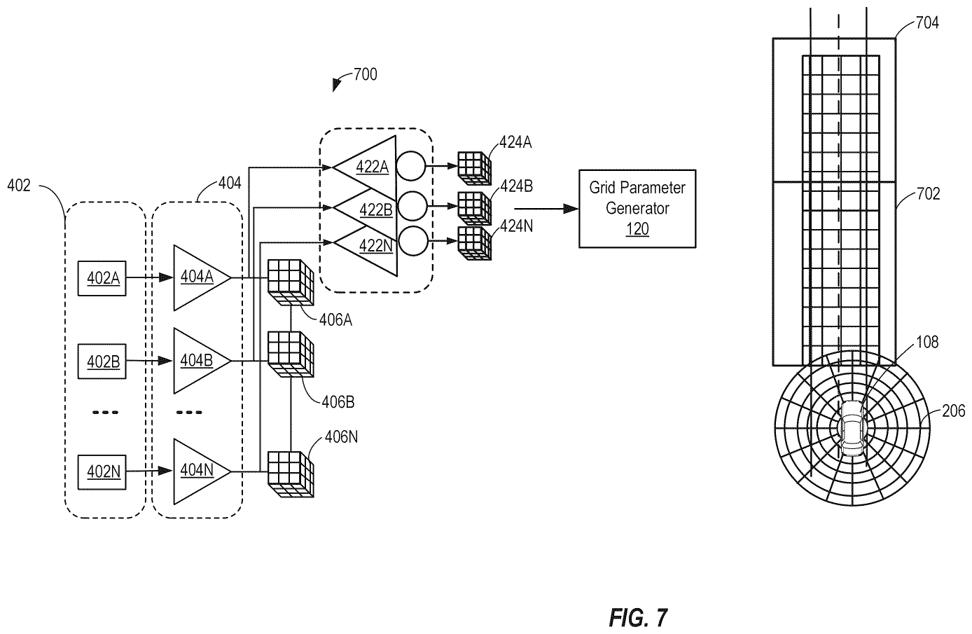

FIG. 7 depicts a system 700 for placing one or more grids on an extrapolated model of a road in accordance with aspects of the present disclosure. The system 700 may include components previously described with reference to FIG. 4, such as sensors 402A-402N configured to obtain second sensor input, and PV encoders 404A-404N configured to receive the second sensor input and generate PV encoder output tensors 406A-406N. In some aspects, the system 700 may include a PV road model 702 and a PV extrapolated road model 704. In some aspects, the PV road model 702 may represent detected road features that are within a detection range of sensors 402A-402N. For example, the sensors 402A-402N may provide sensor data for lanes, curbs, markings, and other road attributes, within a certain distance of an ego vehicle.

In some aspects, the PV road model 702 may be generated based on the PV encoder output tensors 406A-406N. For example, the PV road model 702 may be based on the detected road features that are within a detection range of sensors 402A-402N. In some aspects, the PV extrapolated road model 704 may predict the continuation of a road in regions that are occluded, distant, or outside the field of view of the sensors 402A-402N. In some aspects, the grid parameter generator 120 may receive inputs from both the PV road model 702 and the PV extrapolated road model 704. The grid parameter generator 120 may analyze the road features and their extrapolations to determine appropriate parameters for placing grids. The grid parameters output by the grid parameter generator 120 may define characteristics such as the grid size, resolution, and orientation, based on the combined information from the PV road model 702 and the PV extrapolated road model 704.

In some aspects, by considering both the detected road features from the PV road model 702 and the extrapolated road information from the PV extrapolated road model 704, the grid parameter generator 120 may generate grid parameters that place grids in areas of the PV extrapolated road model 704 in order to provide object detection and tracking capabilities that might be outside of the range of the sensors 402A-402N. In some aspects, the placement of a grid may take into account the geometric limit of a main grid, such as main grid 206, and may extend beyond it, relying on the extrapolated road model to anticipate and cover relevant areas.

### Example Artificial Intelligence System for Object Detection

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as an object detection system in autonomous driving.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

### Example Artificial Intelligence System for Object Detection

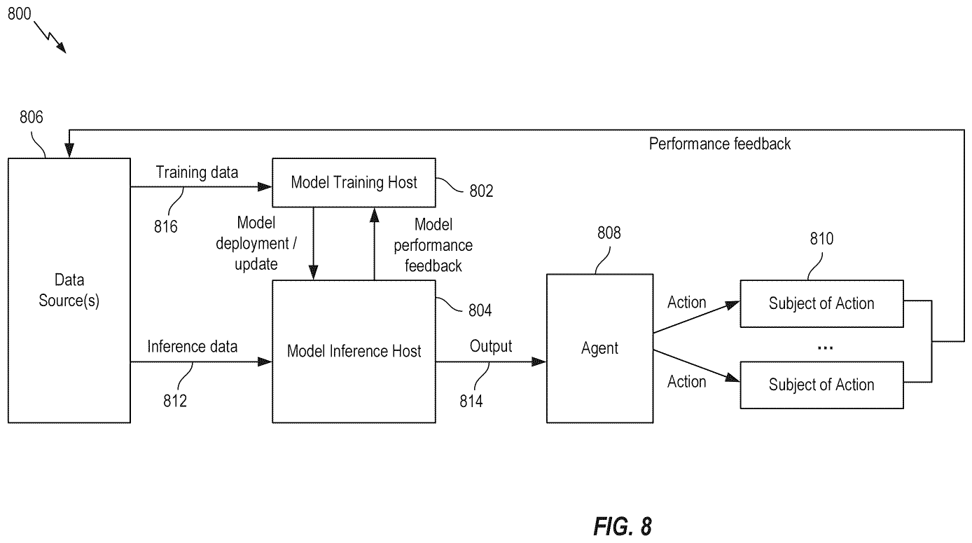

FIG. 8 is a diagram illustrating an example AI architecture 800 that may be used to implement the machine learning models and object detection techniques described in this disclosure, including use of dynamic grid(s). As illustrated, the architecture 800 includes multiple logical entities, such as a model training host 802 for training the machine learning models for object detection, a model inference host 804 for running inference using the trained models for object detection and tracking, data source(s) 806 providing training and inference data, and an agent 808 that utilizes the models'output. This AI architecture could be used to enable the disclosed object detection techniques in various machine learning applications.

The model inference host 804, in the architecture 800, is configured to run the trained machine learning models based on inference data 812 provided by data source(s) 806. The model inference host 804 may produce an output 814 (e.g., detected objects, scene representations) based on the inference data 812, which is then provided as input to the agent 808. The model inference host 804 utilizes the object detection techniques described in this disclosure to generate accurate object detections and scene representations, enabling downstream tasks such as object tracking and motion planning.

The agent 808 may be an element or entity that utilizes the output of the machine learning models hosted by the model inference host 804. The agent 808 could be a software component, a hardware accelerator, or a system that leverages the detected objects and scene representations produced by the models for various downstream tasks such as autonomous navigation, collision avoidance, or driver assistance systems.

For example, if the output 814 from the model inference host 804 includes detected objects with their positions and velocities, the agent 808 may be an object tracking system that uses this information to maintain consistent object identities over time. As another example, if the output 814 is a comprehensive scene representation produced using a dynamic grid, such as by fusing data from multiple grids, the agent 808 could be a motion planning module that generates safe and efficient trajectories for a vehicle.

After receiving the output 814 from the model inference host 804, the agent 808 may determine how to utilize it. For instance, if the agent 808 is an object tracking system, it may use the detected objects to update their trajectories and predict future positions. If the agent 808 decides to use the output 814, it may apply it to the subject of the action 810, which represents the data being processed or enhanced. In the object tracking example, the subject of action 810 would be the sequence of detected objects over time. In some cases, the agent 808 and subject of action 810 may be tightly integrated.

The data sources 806 may be configured to collect data used as training data 816 for the model training host 802 to train the object detection machine learning models. The data sources 806 may also provide inference data 812 to the model inference host 804. This data could come from various entities and may include the subject of action 810. For example, for training an object detection model, the data sources 806 may collect synchronized sensor data from cameras, LiDAR, radar, and other sensors mounted on vehicles. The model training host 802 can then monitor the models'performance on this data to determine if retraining or fine-tuning with the object detection model is necessary to improve accuracy. In some cases, the agent 808 and the subject of action 810 are the same entity.

The data sources 806 may be configured for collecting data that is used as training data 816 for training the object detection machine learning models with dynamic grids. The data sources 806 may also provide inference data 812 (also referred to as input data) for feeding the trained models during inference. In particular, the data sources 806 may collect data relevant to the object detection task at hand, such as sensor data from various modalities, grid parameters, object location information, or the like. This data may come from various sources, including the subject of action 810, which represents the data being processed by the models. The collected data is provided to the model training host 802 for training and fine-tuning the object detection model. For example, after the subject of action 810 (e.g., sensor data with known object positions) is processed by the models, the output 814 (e.g., detected objects and scene representations) may be compared to ground truth data to evaluate the models'performance. If the output 814 is not sufficiently accurate, this performance feedback may be used by the model training host 802 to further train the model using the disclosed object detection techniques, aiming to improve detection accuracy and robustness. The updated models may then be deployed to the model inference host 804.

In certain aspects, the model training host 802 may be deployed at or with the same or a different entity than that in which the model inference host 804 is deployed. For example, to offload model training processing, which can impact the performance of the model inference host 804, the model training host 802 may be deployed at a model server as further described herein. Further, in some cases, training and/or inference may be distributed amongst devices in a decentralized or federated fashion.

In some aspects, object detection machine learning models utilizing dynamic grid(s) are deployed at or on a computing device for enhancing the performance of object detection and tracking tasks. More specifically, a model inference host, such as model inference host 804 in FIG. 8, may be deployed at or on the computing device for running the object detection model using dynamic grid(s) to improve detection accuracy and object tracking in dynamic environments.

In some other aspects, object detection machine learning models are deployed at or on an embedded system or mobile device for enabling efficient on-device inference. More specifically, a model inference host, such as model inference host 804 in FIG. 8, may be deployed at or on the embedded system or mobile device for running the models to obtain high-quality scene representations while meeting resource constraints.

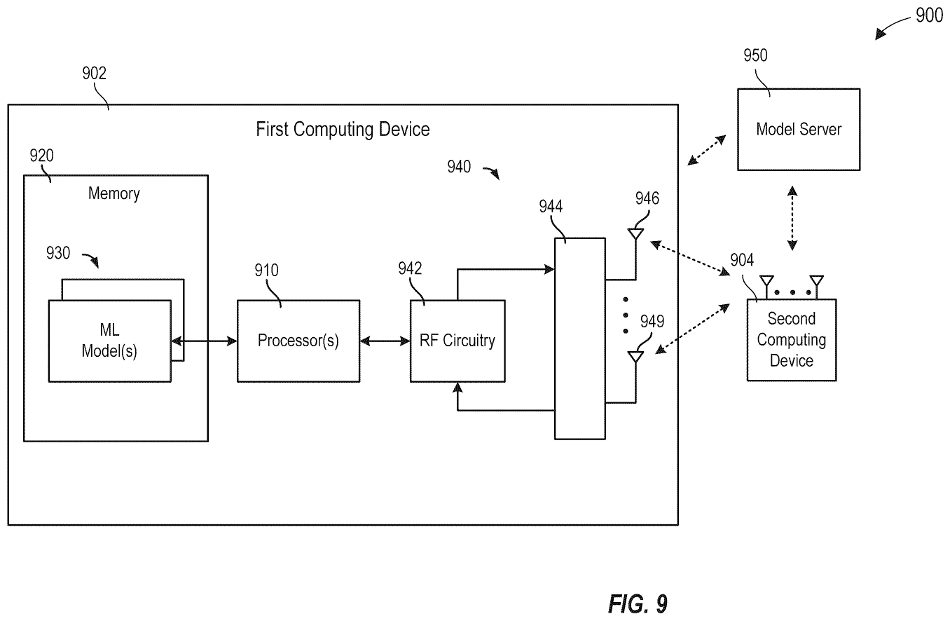

FIG. 9 illustrates an example AI architecture 900 of a first computing device 902 that is in communication with a second computing device 904. The first computing device 902 may be a server or cloud computing platform as described herein with respect to FIG. 8. Similarly, the second computing device 904 may be an embedded system or mobile device as described herein with respect to FIG. 8. Note that the AI architecture of the first computing device 902 may be applied to the second computing device 904.

The first computing device 902 may be, or may include, a chip, system on chip (SoC), a system in package (SiP), chipset, package, or device that includes one or more processors, processing blocks, or processing elements (collectively “the processor 910”) and one or more memory blocks or elements (collectively “the memory 920”).

As an example, in a model inference mode, the processor 910 may transform input data (e.g., sensor data, grid parameters) into a format suitable for the object detection models. The processor 910 may then run the models on the formatted input data to generate scene representations and detection information. The processor 910 may be coupled to a transceiver 940 for transmitting the output data to and/or receiving input data from, via one or more antennas 946-949, one or more connected devices, such as second computing device 904. The transceiver 940 includes interface circuitry 942 and 944 for converting between the digital signals of the processor and any transmission protocol used by the connected devices. The connected devices may include sensors that provide environmental data input, actuators that implement vehicle control commands (such as steering and braking), displays that present detection information, or storage devices that store model data. In some aspects, a connected device may communicate with processor 910 using an interface connection other than transceiver 940 and based on its function and requirements. For example, one or more connected devices may be part of or directly coupled to the first computing device 902.

When receiving input data via the connected devices (e.g., from the second computing device 904), the transceiver interface circuitry 942 and 944 may convert the received signals to a baseband frequency and then to digital signals for processing by the processor 910. The processor 910 may format the digital input signals and feed them into the object detection model for inference.

One or more ML models 930 may be stored in the memory 920 and accessible to the processor(s) 910. In certain cases, different ML models 930 with different characteristics may be stored in the memory 920, and a particular ML model 930 may be selected based on its characteristics and/or application as well as characteristics and/or conditions of the first computing device 902 (e.g., a power state, a mobility state, a battery reserve, a temperature, etc.). For example, the ML models 930 may have different inference data and output pairings (e.g., different types of sensor data produce different types of output), different levels of accuracies (e.g., high accuracy models for critical tasks), different latencies (e.g., processing times suitable for real-time applications), different ML model sizes (e.g., optimized for embedded deployment), different coefficients or weights, etc.

The processor 910 may use the ML model 930 to produce output data (e.g., the output 814 of FIG. 8) based on input data (e.g., the inference data 812 of FIG. 8), for example, as described herein with respect to the inference host 804 of FIG. 8. The ML model 930 may be used to perform any of various AI-enhanced tasks, such as those listed above.

As an example, the ML model 930 may take sensor data from one or more sensors and grid parameters as input to predict object detections and scene representations, such as using one or more example multi-grid sensor fusion techniques previously described. The input data may include, for example, images from cameras, point clouds from LiDAR, radar signals, or the like, along with dynamically determined grid parameters specifying grid positions, sizes, and resolutions. The output data may include, for example, detected objects with associated positions, velocities, and classifications, as well as scene representations that may integrate information across multiple grids. In certain aspects, the output data may be considered a “virtual” result in that it synthesizes information from multiple sources to create a unified understanding of the environment. Note that other input data and/or output data may be used in addition to or instead of the examples described herein, depending on the object detection task and the available data.

In certain aspects, a model server 950 may perform any of various ML model lifecycle management (LCM) tasks for the first computing device 902 and/or the second computing device 904. The model server 950 may operate as the model training host 802 and update the ML model 930 using training data from various driving scenarios to improve performance. In some cases, the model server 950 may operate as the data source 806 to collect and host training data, inference data, and/or performance feedback associated with an ML model 930 across different environments. In certain aspects, the model server 950 may host various types and/or versions of the ML models 930 for the first computing device 902 and/or the second computing device 904 to download.

In some cases, the model server 950 may monitor and evaluate the performance of the ML model 930 to trigger one or more lifecycle management (LCM) tasks. For example, the model server 950 may determine whether to activate or deactivate the use of a particular object detection model at the first computing device 902 and/or the second computing device 904, based on factors such as the accuracy requirements, computational budget, and energy constraints of each device. The model server 950 may then provide instructions to the respective devices to manage their model usage accordingly. In some cases, the model server 950 may determine whether to switch to a different variant of the object detection ML model 930 at the first computing device 902 and/or the second computing device 904, based on changes in the operating conditions or performance objectives. For instance, the model server may instruct a device to switch from a high-resolution model to a lower-resolution one when computational resources are limited. In yet further examples, the model server 950 may act as a central coordinator for collaborative learning of object detection models across multiple devices, using techniques such as federated learning to train a global model from locally computed updates while preserving data privacy.

### Example Artificial Intelligence Model

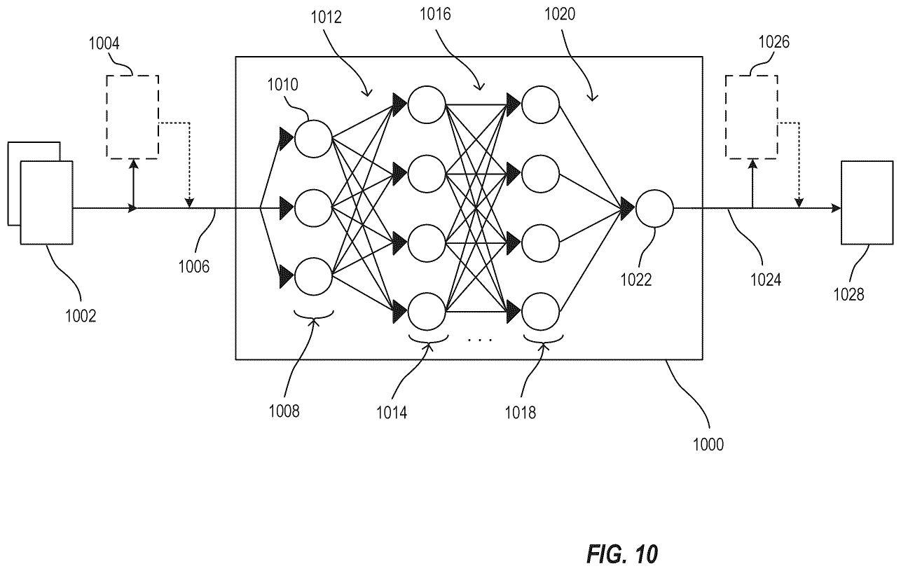

FIG. 10 is an illustrative block diagram of an ANN 1000 that can be used to implement the object detection techniques described in this disclosure.

ANN 1000 may receive input data 1006, which may include one or more bits of data 1002, pre-processed data output from pre-processor 1004 (optional), or some combination thereof. Here, data 1002 may include sensor data from various modalities (e.g., cameras, LiDAR, radar), grid parameters, and object location information. In some aspects, data 1002 may include training data from multiple domains for domain generalization, inference data from a specific domain for domain adaptation, or the like, e.g., depending on the stage of development and/or deployment of ANN 1000. Pre-processor 1004 may, for example, process all or a portion of data 1002 to synchronize sensor inputs, apply calibration parameters, or normalize the data. In some implementations, pre-processor 1004 may add additional data to data 1002, such as time stamps or sensor metadata.

ANN 1000 includes at least one first layer 1008 of artificial neurons 1010 (e.g., perceptrons) to process input data 1006 and provide resulting first layer output data via edges 1012 to at least a portion of at least one second layer 1014. Second layer 1014 processes data received via edges 1012 and provides second layer output data via edges 1016 to at least a portion of at least one third layer 1018. Third layer 1018 processes data received via edges 1016 and provides third layer output data via edges 1020 to at least a portion of a final layer 1022 including one or more neurons to provide output data 1024. All or part of output data 1024 may be further processed in some manner by (optional) post-processor 1026. Thus, in certain examples, ANN 1000 may provide output data 1028 that is based on output data 1024, post-processed data output from post-processor 1026, or some combination thereof. Post-processor 1026 may be included within ANN 1000 in some other implementations. Post-processor 1026 may, for example, process all or a portion of output data 1024 which may result in output data 1028 being different, at least in part, to output data 1024, e.g., as result of data being changed, replaced, deleted, etc. In some implementations, post-processor 1026 may be configured to add additional data to output data 1024, such as domain-specific post-processing or adaptation. In this example, second layer 1014 and third layer 1018 represent intermediate or hidden layers that may be arranged in a hierarchical or other like structure. Although not explicitly shown, there may be one or more further intermediate layers between the second layer 1014 and the third layer 1018.

The structure and training of artificial neurons 1010 in the various layers may be tailored to specific requirements of an application, such as multi-grid sensor fusion for object detection and tracking. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process to learn domain-invariant representations. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 812 in FIG. 8) across different domains. Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 1000 and a number of layers and a number of artificial neurons in each layer, as well as selecting activation functions, a loss function, training processes, etc., to enable domain generalization and adaptation. Once an initial model has been designed, training of the model may be conducted using training data from multiple domains. Training data may include one or more datasets within which ANN 1000 may detect, determine, identify or ascertain patterns that are consistent across domains. Training data may represent various types of information, including written, visual, audio, environmental context, operational properties, etc., from different domains. During training, parameters of artificial neurons 1010 may be changed, such as to minimize or otherwise reduce a loss function or a cost function that measures the model's performance across domains. A training process may be repeated multiple times to fine-tune ANN 1000 with each iteration to improve its domain generalization capability.

Various ANN model structures are available for consideration in the context of domain generalization and adaptation. For example, in a feedforward ANN structure each artificial neuron 1010 in a layer receives information from the previous layer and likewise produces information for the next layer. In a convolutional ANN structure, some layers may be organized into filters that extract domain-invariant features from data (e.g., training data and/or input data). In a recurrent ANN structure, some layers may have connections that allow for processing of data across time, such as for processing information having a temporal structure, such as time series data forecasting across domains.

In an autoencoder ANN structure, compact representations of data may be processed and the model trained to predict or potentially reconstruct original data from a reduced set of features that capture domain-invariant patterns. An autoencoder ANN structure may be useful for tasks related to dimensionality reduction and data compression in a domain-agnostic manner.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models in a domain-adaptive way. For example, a GAN could be used to generate realistic training data for a new domain to improve the domain generalization of another model.

A transformer ANN structure makes use of attention mechanisms that may enable the model to process input sequences in a parallel and efficient manner while capturing long-range dependencies and domain-specific patterns. An attention mechanism allows the model to focus on different parts of the input sequence at different times based on their relevance to the task and domain. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences in a domain-adaptive way. The output of a transformer ANN structure may be obtained by applying a linear transformation to the output of a final attention layer. A transformer ANN structure may be of particular use for tasks that involve sequence modeling, or other like processing, across different domains.

Another example type of ANN structure, is a model with one or more invertible layers. Models of this type may be inverted or “unwrapped” to reveal the input data that was used to generate the output of a layer, which can be useful for understanding how the model adapts to different domains.

Other example types of ANN model structures that can be used for domain generalization and adaptation include fully connected neural networks (FCNNs) and long short-term memory (LSTM) networks.

ANN 1000 or other ML models may be implemented in various types of processing circuits along with memory and applicable instructions therein, for example, as described herein with respect to FIGS. 8 and 9. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models that can perform object detection.

### Aspects of Artificial Intelligence Model Training

There are a variety of model training techniques and processes that may be used prior to, or at some point following, deployment of an ML model, such as ANN 1000 of FIG. 10, to enable object detection.

For example, training data may include synchronized sensor data from multiple modalities, grid parameter settings, and ground truth annotations of objects in various environments. This data can be used to train the model to accurately detect and track objects, adjust grid parameters dynamically, and fuse information across multiple grids. In certain instances, the training data may originate from real-world driving scenarios, simulation environments, or a combination of both. The training data collection process can be performed offline, resulting in a static dataset for batch training, or online, where new samples are continuously incorporated into the model training pipeline. For offline training, data collection and model updates can occur at a central location (e.g., a datacenter) or be distributed across multiple nodes (e.g., a network of cameras). For online training, the model may be adapted locally on each device or by a remote server that receives streaming data from the devices.

In certain instances, all or part of the training data may be shared within a communication system, or even shared (or obtained from) outside of the communication system.

Once an ML model has been trained with training data from multiple domains, its performance may be evaluated on held-out test data from both seen and unseen domains. In some scenarios, evaluation/verification tests may use a validation dataset, which may include data not in the training data, to compare the model's performance to baseline or other benchmark information across different domains. If model performance is deemed unsatisfactory, it may be beneficial to fine-tune the model, e.g., by changing its architecture, re-training it on the data with domain-specific adjustments, or using different optimization techniques that promote domain generalization, etc. Once a model's performance is deemed satisfactory across a wide range of domains, the model may be deployed accordingly. In certain instances, a model may be updated in some manner, e.g., all or part of the model may be changed or replaced, or undergo further training with data from new domains, just to name a few examples.

As part of a training process for an ANN, such as ANN 1000 of FIG. 10, parameters affecting the functioning of the artificial neurons and layers may be adjusted to learn domain-invariant representations. For example, backpropagation techniques may be used to train the ANN by iteratively adjusting weights and/or biases of certain artificial neurons associated with errors between a predicted output of the model and a desired output that may be known or otherwise deemed acceptable across different domains. Backpropagation may include a forward pass, a loss function, a backward pass, and a parameter update that may be performed in training iteration. The process may be repeated for a certain number of iterations for each set of training data until the weights of the artificial neurons/layers are adequately tuned to minimize domain-specific biases.

Backpropagation techniques associated with a loss function may measure how well a model is able to predict a desired output for a given input across different domains. An optimization algorithm may be used during a training process to adjust weights and/or biases to reduce or minimize the loss function which should improve the performance of the model on unseen domains. There are a variety of optimization algorithms that may be used along with backpropagation techniques or other training techniques to promote domain generalization. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function that measures cross-domain performance. A mini-batch gradient descent technique, which is a variant of gradient descent, may involve updating weights/biases using a small batch of training data from different domains rather than the entire dataset. A momentum technique may accelerate an optimization process by adding a momentum term to update or otherwise affect certain weights/biases in a domain-agnostic way.

An adaptive learning rate technique may adjust a learning rate of an optimization algorithm associated with one or more characteristics of the training data from different domains. A batch normalization technique may be used to normalize inputs to a model in order to stabilize a training process and potentially improve the performance of the model across domains.

A “dropout” technique may be used to randomly drop out some of the artificial neurons from a model during a training process, e.g., in order to reduce overfitting to specific domains and potentially improve the generalization of the model to unseen domains.

An “early stopping” technique may be used to stop an on-going training process early, such as when a performance of the model using a validation dataset from a different domain starts to degrade.

Another example technique includes data augmentation to generate additional training data by applying domain-specific transformations to all or part of the training information.

A transfer learning technique may be used which involves using a pre-trained model as a starting point for training a new model on a different domain, which may be useful when training data from the new domain is limited or when there are multiple tasks that are related to each other across domains.

A multi-task learning technique may be used which involves training a model to perform multiple tasks simultaneously across different domains to potentially improve the performance of the model on one or more of the tasks in a domain-agnostic way. Hyperparameters or the like may be input and applied during a training process in certain instances to control the degree of domain generalization.

Another example technique that may be useful with regard to an ML model for domain generalization is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model across different domains.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored, while preserving its domain generalization capability.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training of object detection machine learning models on data distributed across multiple devices or organizations, without the need to centralize the data or the training process. Federated learning is particularly useful when the training data is sensitive or subject to privacy constraints, or when it is impractical, inefficient, or expensive to gather all the data in one place.

For instance, autonomous vehicles may collaboratively train an object detection model by sharing model updates rather than raw sensor data. Each vehicle can train the model locally using its own sensor data and then send the updated model parameters to a central server, which aggregates the updates to improve the global model.

In some implementations, one or more devices or services may support processes relating to the usage, maintenance, activation, and reporting of machine learning models that utilize dynamic grid techniques for object detection as described above. In certain instances, all or part of the training data or the trained model may be shared across multiple devices to provide or improve the object detection capabilities. For example, a fleet of vehicles may share model updates to improve detection accuracy in various driving conditions. In some cases, signaling mechanisms may be employed to communicate the capabilities and requirements for performing specific functions related to object detection models, such as the supported sensor modalities, processing power, or ability to collect and share training data. These models may be used to support various applications, such as autonomous driving, advanced driver-assistance systems (ADAS), robotics, or surveillance, where accurate and efficient perception of the environment is crucial.

### Example Operations for Performing Object Detection

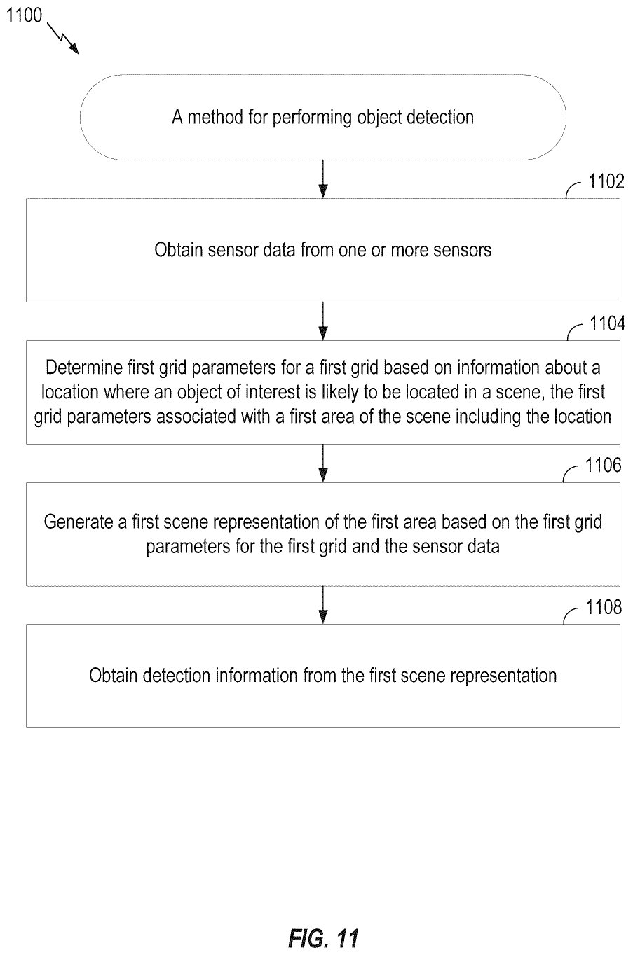

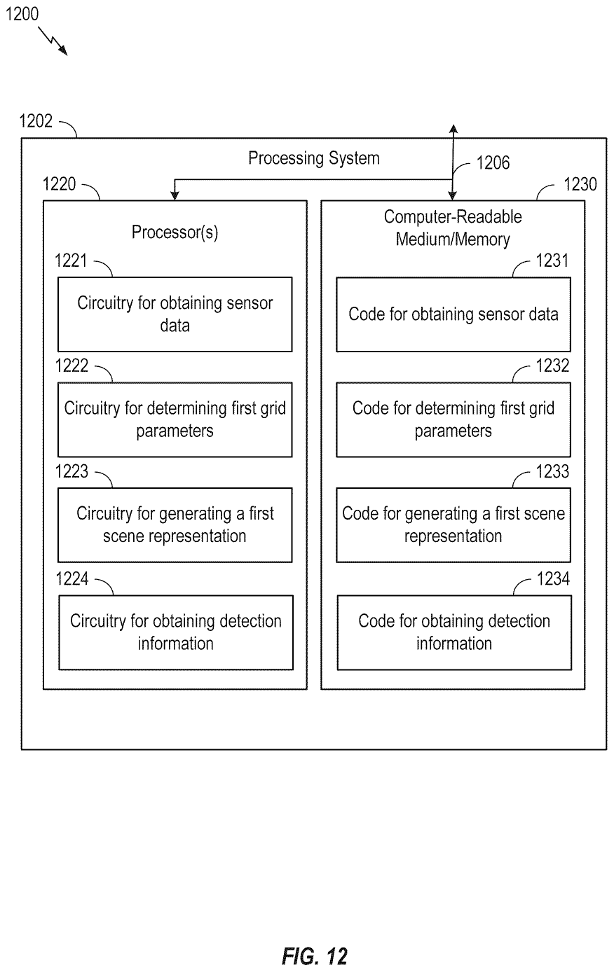

FIG. 11 depicts an example method 1100 for performing object detection. In one aspect, method 1100, or any aspect related to it, may be performed by an apparatus, such as processing system 1200 of FIG. 12, which includes various components operable, configured, or adapted to perform method 1100. Method 1100 provides beneficial technical effects by improving object detection accuracy and computational efficiency. By dynamically adjusting grid parameters based on object locations, method 1100 provides a technical solution to the challenges of processing sensor data with varying spatial resolutions and areas of interest.

Method 1100 begins at 1102 with obtaining sensor data from one or more sensors. For example, as depicted in FIG. 1-3, one or more sensors (114/302A-302N) may obtain sensor data.

Method 1100 may then proceed to 1104, with determining first grid parameters for a first grid based on information about a location where an object of interest is likely to be located in a scene, the first grid parameters associated with a first area of the scene including the location.

Method 1100 may then proceed to 1106, with generating a first scene representation of the first area based on the first grid parameters for the first grid and the sensor data. For example, the view transformer 308 may use the grid parameters 122 and PV encoder output tensors 306A-306N to generate the scene representation tensor 310, as depicted in FIG. 3

Method 1100 may then proceed to 1108 with obtaining detection information from the first scene representation. For example, the BEV encoders and decoders 312A-312N may process the scene representation tensor 310 to generate output tensors 314A-314N, representing detected objects and their properties.

In some aspects, method 1100 further includes generating a second scene representation of a second area of the scene based on a second grid and the sensor data; and using the detection information from the first scene representation and the second scene representation to generate a combined scene representation of the first area and the second area.

In some aspects of method 1100, obtaining and fusing the detection information comprises: performing at least one of: when the first grid and the second grid are within a threshold distance of each other, extracting features from the first scene representation and the second scene representation and performing feature-level fusion of the extracted features; or when the first grid and the second grid are not within the threshold distance of each other, generating one or more first object detections from the first scene representation and one or more second object detections from the second scene representation and performing object-level fusion of the one or more first object detections with the one or more second object detections.

In some aspects, method 1100 further includes transitioning between feature-level fusion and object-level fusion based on a change in a relative position of the first grid and the second grid.

In some aspects of method 1100, the information about the location comprises at least one of: map data; a road model; the sensor data; a trajectory of an object; a speed of the object; an orientation of the object; a location of the object; or a vehicle-to-everything (V2X) communication.

In some aspects of method 1100, the first grid parameters comprise at least one of: a position of the first grid; a size of the first grid; a shape of the first grid; an orientation of the first grid; or a resolution of the first grid.

In some aspects of method 1100, one or more of the extracted features represent object portions in the first grid and the second grid; and performing feature-level fusion comprises combining the one or more of the extracted features.

In some aspects, method 1100 further includes adjusting a size of the first grid based on at least one of a speed of an object or uncertainty of a position of the object; and adjusting a position of the first grid to follow movement of the object.

In some aspects, method 1100 further includes adjusting at least one of a number of grids or a resolution of the first grid based on available computational resources.

In some aspects, method 1100 further includes obtaining information about multiple locations; determining a priority level for each of the multiple locations; and allocating one or more grids to one or more of the multiple locations based on the determined priority levels. In some aspects, determining a priority level for each of the multiple locations comprises to evaluate at least one of: distance of each of the multiples locations from the one or more sensors; type of object likely to be located in each of the multiple location; predicted object trajectory in each of the multiple locations; or road feature complexity in each of the multiple locations.

In some aspects of method 1100, determining the first grid parameters comprises determining a dimension of the first grid based on uncertainty associated with the location of the object relative to a position of the one or more sensors.

In some aspects of method 1100, determining the first grid parameters comprises detecting degraded sensor data associated with a portion of the first grid; and increasing a size of the first grid based on the degraded sensor data.

In some aspects of method 1100, the location comprises a curved road segment, and the first grid parameters define a non-rectangular shape for the first grid aligned with geometry of the curved road segment.

In some aspects, method 1100 further includes receiving one or more vehicle-to-everything (V2X) communications that indicate a second location of a second object; determining second grid parameters, associated with a second area of the scene, for a second grid based on the second location; generating a second scene representation of the second area based on the second grid parameters for the second grid and the sensor data; and obtaining additional detection information from the second scene representation.

In some aspects of method 1100, the first grid comprises a BEV grid providing a top-down perspective of the first area.

Note that FIG. 11 is just one example of a method, and other methods including fewer, additional, or alternative steps are possible consistent with this disclosure.

### Example Processing System Performing Object Detection

FIG. 12 depicts aspects of an example processing system 1200.

The processing system 1200 includes a processing system 1202 includes one or more processors 1220. The one or more processors 1220 are coupled to a computer-readable medium/memory 1230 via a bus 1206. In certain aspects, the computer-readable medium/memory 1230 is configured to store instructions (e.g., computer-executable code) that when executed by the one or more processors 1220, cause the one or more processors 1220 to perform the method 1100 described with respect to FIG. 11, or any aspect related to it, including any additional steps or sub-steps described in relation to FIG. 11.

In the depicted example, computer-readable medium/memory 1230 stores code 1231 (e.g., executable instructions) for obtaining sensor data from one or more sensors, code 1232 for determining first grid parameters for a first grid based on information about a location where an object of interest is likely to be located in a scene, code 1233 for generating a first scene representation of the first area based on the first grid parameters for the first grid and the sensor data, and code 1234 for obtaining detection information from the first scene representation. Processing of the code 1231-1234 may enable and cause the processing system 1200 to perform the method 1100 described with respect to FIG. 11, or any aspect related to it.

The one or more processors 1220 include circuitry configured to implement (e.g., execute) the code stored in the computer-readable medium/memory 1230, including circuitry 1221 for obtaining sensor data from one or more sensors, circuitry 1222 for determining first grid parameters for a first grid based on information about a location where an object of interest is likely to be located in a scene, circuitry 1223 for generating a first scene representation of the first area based on the first grid parameters for the first grid and the sensor data and circuitry 1224 for obtaining detection information from the first scene representation. Processing with circuitry 1221-1224 may enable and cause the processing system 1200 to perform the method 1100 described with respect to FIG. 11, or any aspect related to it or any other aspects of techniques discussed herein.

### Example Clauses

Implementation examples are described in the following numbered clauses:

Clause 1: A method for performing object detection, comprising: obtaining sensor data from one or more sensors; determining first grid parameters for a first grid based on information about a location where an object of interest is likely to be located in a scene, the first grid parameters associated with a first area of the scene including the location; generating a first scene representation of the first area based on the first grid parameters for the first grid and the sensor data; and obtaining detection information from the first scene representation.

Clause 2: The method of Clause 1, further comprising: generating a second scene representation of a second area of the scene based on a second grid and the sensor data; and fusing the detection information from the first scene representation and the second scene representation to generate a combined scene representation of the first area and the second area.

Clause 3: The method of Clause 2, wherein obtaining and fusing the detection information comprises performing at least one of: when the first grid and the second grid are within a threshold distance of each other, extracting features from the first scene representation and the second scene representation and performing feature-level fusion of the extracted features; or when the first grid and the second grid are not within the threshold distance of each other, generating one or more first object detections from the first scene representation and one or more second object detections from the second scene representation and performing object-level fusion of the one or more first object detections with the one or more second object detections.

Clause 4: The method of Clause 3, wherein: one or more of the extracted features represent object portions in the first grid and the second grid; and performing feature-level fusion comprises combining the one or more of the extracted features.

Clause 5: The method of any one of Clauses 1-4, further comprising: transition between feature-level fusion and object-level fusion based on a change in a relative position of the first grid and the second grid.

Clause 6: The method of any one of Clauses 1-5, wherein the information about the location comprises at least one of: map data; a road model; the sensor data; a trajectory of an object; a speed of the object; an orientation of the object; a location of the object; or a vehicle-to-everything (V2X) communication.

Clause 7: The method of any one of Clauses 1-6, wherein the first grid parameters comprise at least one of: a position of the first grid; a size of the first grid; a shape of the first grid; an orientation of the first grid; or a resolution of the first grid.

Clause 8: The method of any one of Clauses 1-7, further comprising: adjusting a size of the first grid based on at least one of a speed of an object or uncertainty of a position of the object; and adjusting a position of the first grid to follow movement of the object.

Clause 9: The method of any of Clauses 1-8, further comprising: adjusting at least one of a number of grids or a resolution of the first grid based on available computational resources.

Clause 10: The method of any one of Clauses 1-9, further comprising: obtaining information about multiple locations; determining a priority level for each of the multiple locations; and allocating one or more grids to one or more of the multiple locations based on the determined priority levels.

Clause 11: The method Clause 10, wherein determining the priority level for each of the multiple locations comprises evaluating at least one of: distance of each of the multiple locations from the one or more sensors; type of object likely to be located in each of the multiple location; predicted object trajectory in each of the multiple locations; or road feature complexity in each of the multiple locations.

Clause 12: The method of any one of Clauses 1-11, wherein determining the first grid parameters comprises: determining a dimension of the first grid based on uncertainty associated with the location relative to a position of the one or more sensors.

Clause 13: The method of any one of Clauses 1-12, wherein determining the first grid parameters comprises: detecting degraded sensor data associated with a portion of the first grid; and increasing a size of the first grid based on the degraded sensor data.

Clause 14: The method of any one of Clauses 1-13, wherein the location comprises a curved road segment, and wherein the first grid parameters define a non-rectangular shape for the first grid aligned with geometry of the curved road segment.

Clause 15: The method of any one of Clauses 1-14, further comprising: receiving one or more vehicle-to-everything (V2X) communications that indicate a second location; determining second grid parameters, associated with a second area of the scene, for a second grid based on the second location; generating a second scene representation of the second area based on the second grid parameters for the second grid and the sensor data; and obtaining additional detection information from the second scene representation.

Clause 16: The method of any one of Clauses 1-15, wherein the first grid comprises a BEV grid providing a top-down perspective of the first area.

Clause 17: One or more apparatuses, comprising: one or more memories comprising executable instructions; and one or more processors configured to execute the executable instructions and cause the one or more apparatuses to perform a method in accordance with any one of clauses 1-16.

Clause 18: One or more apparatuses, comprising: one or more memories; and one or more processors, coupled to the one or more memories, configured to cause the one or more apparatuses to perform a method in accordance with any one of Clauses 1-16.

Clause 19: One or more apparatuses, comprising: one or more memories; and one or more processors, coupled to the one or more memories, configured to perform a method in accordance with any one of Clauses 1-16.

Clause 20: One or more apparatuses, comprising means for performing a method in accordance with any one of Clauses 1-16.

Clause 21: One or more non-transitory computer-readable media comprising executable instructions that, when executed by one or more processors of one or more apparatuses, cause the one or more apparatuses to perform a method in accordance with any one of Clauses 1-16.

Clause 22: One or more computer program products embodied on one or more computer-readable storage media comprising code for performing a method in accordance with any one of Clauses 1-16.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for object detection, comprising a processing system that includes one or more processors and one or more memories coupled with the one or more processors, the processing system configured to cause the apparatus to:
obtain sensor data from one or more sensors;
determine first grid parameters for a first grid based on information about a location where an object of interest is likely to be located in a scene, the first grid parameters associated with a first area of the scene including the location;
generate a first scene representation of the first area based on the first grid parameters for the first grid and the sensor data; and
obtain detection information from the first scene representation.

2. The apparatus of claim 1, wherein the processing system is configured to cause the apparatus to:
generate a second scene representation of a second area of the scene based on a second grid and the sensor data; and
fuse the detection information from the first scene representation and the second scene representation to generate a combined scene representation of the first area and the second area.

3. The apparatus of claim 2, wherein to obtain and fuse the detection information comprises to perform at least one of:
when the first grid and the second grid are within a threshold distance of each other, extract features from the first scene representation and the second scene representation and perform feature-level fusion of the extracted features; or
when the first grid and the second grid are not within the threshold distance of each other, generate one or more first object detections from the first scene representation and one or more second object detections from the second scene representation and perform object-level fusion of the one or more first object detections with the one or more second object detections.

4. The apparatus of claim 3, wherein:
one or more of the extracted features represent object portions in the first grid and the second grid; and
to perform feature-level fusion comprises to combine the one or more of the extracted features.

5. The apparatus of claim 3, wherein the processing system is further configured to cause the apparatus to transition between feature-level fusion and object-level fusion based on a change in a relative position of the first grid and the second grid.

6. The apparatus of claim 1, wherein the information about the location comprises at least one of:
map data;
a road model;
the sensor data;
a trajectory of an object;
a speed of the object;
an orientation of the object;
a location of the object; or
a vehicle-to-everything (V2X) communication.

7. The apparatus of claim 1, wherein the first grid parameters comprise at least one of:
a position of the first grid;
a size of the first grid;
a shape of the first grid;
an orientation of the first grid; or
a resolution of the first grid.

8. The apparatus of claim 1, wherein the processing system is further configured to cause the apparatus to:
adjust a size of the first grid based on at least one of a speed of an object or uncertainty of a position of the object; and
adjust a position of the first grid to follow movement of the object.

9. The apparatus of claim 1, wherein the processing system is further configured to cause the apparatus to:
adjust at least one of a number of grids or a resolution of the first grid based on available computational resources.

10. The apparatus of claim 1, wherein the processing system is further configured to cause the apparatus to:
obtain information about multiple locations;
determine a priority level for each of the multiple locations; and
allocate one or more grids to one or more of the multiple locations based on the determined priority levels.

11. The apparatus of claim 10, wherein to determine the priority level for each of the multiple locations comprises to evaluate at least one of:
distance of each of the multiple locations from the one or more sensors;
type of object likely to be located in each of the multiple locations;
predicted object trajectory in each of the multiple locations; or
road feature complexity in each of the multiple locations.

12. The apparatus of claim 1, wherein to determine the first grid parameters comprises to:
determine a dimension of the first grid based on uncertainty associated with the location relative to a position of the one or more sensors.

13. The apparatus of claim 1, wherein to determine the first grid parameters comprises to:
detect degraded sensor data associated with a portion of the first grid; and
increase a size of the first grid based on the degraded sensor data.

14. The apparatus of claim 1, wherein the location comprises a curved road segment, and wherein the first grid parameters define a non-rectangular shape for the first grid aligned with geometry of the curved road segment.

15. The apparatus of claim 1, wherein the processing system is further configured to:
receive one or more vehicle-to-everything (V2X) communications that indicate a second location;
determine second grid parameters, associated with a second area of the scene, for a second grid based on the second location;
generate a second scene representation of the second area based on the second grid parameters for the second grid and the sensor data; and
obtain additional detection information from the second scene representation.

16. The apparatus of claim 1, wherein the first grid comprises a bird's-eye-view grid providing a top-down perspective of the first area.

17. A method for performing object detection, comprising:
obtaining sensor data from one or more sensors;
determining first grid parameters for a first grid based on information about a location where an object of interest is likely to be located in a scene, the first grid parameters associated with a first area of the scene including the location;
generating a first scene representation of the first area based on the first grid parameters for the first grid and the sensor data; and
obtaining detection information from the first scene representation.

18. The method of claim 17, further comprising:
generating a second scene representation of a second area of the scene based on a second grid and the sensor data; and
fusing the detection information from the first scene representation and the second scene representation to generate a combined scene representation of the first area and the second area.

19. The method of claim 18, wherein obtaining and fusing the detection information comprises performing at least one of:
when the first grid and the second grid are within a threshold distance of each other, extracting features from the first scene representation and the second scene representation and performing feature-level fusion of the extracted features; or
when the first grid and the second grid are not within the threshold distance of each other, generating one or more first object detections from the first scene representation and one or more second object detections from the second scene representation and performing object-level fusion of the one or more first object detections with the one or more second object detections.

20. The method of claim 19, wherein:
one or more of the extracted features represent object portions in the first grid and the second grid; and
performing feature-level fusion comprises combining the one or more of the extracted features.
